(19) United States
(12) Patent Application Publication
(10) Pub. No.: US 2004/0262916 A1
(43) Pub. Date: Dec. 30, 2004

(54) Vessel outlet swivel assembly

(76) Inventor: David Byron, Honeoye Falls, NY (US)

Correspondence Address: JAECKLE FLEISCHMANN & MUGEL, LLP, Suite 200, 39 State Street, Rochester, NY, 14614-1310, US

(21) Appl. No.: 10/858,183

(22) Filed: Jun. 1, 2004

Related U.S. Application Data
(60) Provisional application No. 60/474,069, filed on May 29, 2003.
(60) Provisional application No. 60/474,101, filed on May 29, 2003.

(51) Int. Cl. F16L 27/00

(52) U.S. Cl. 285/276

(57) ABSTRACT

A swivel outlet assembly serving as a conduit for fluid flowing from a vessel to a hose has a swivel outlet top that is rotably attached to a swivel outlet base. A bore in the swivel top is in fluid communication at an acute angle with a channel of the swivel outlet base. The swivel outlet base is configured for attachment to a vessel and the swivel outlet top is configured for attachment to a hose. The outlet swivel top can have an integral hose connector. The swivel outlet assembly optimizes the operator's freedom of movement, thereby providing greater versatility, as well as minimizing stress on the hose and connector, therefore reducing the expense associated with maintenance and repair.

### CROSS REFERENCE TO RELATED APPLICATIONS

This application claims the benefit of U.S. Provisional applications No. 60/474,069 and 60/474,101 both filed on May 29, 2003, the entire disclosures of which are incorporated by reference in their entirety for any and all purposes.

### BACKGROUND

Vessels for dispensing a pressurized fluid, such as, for example, sprayers, comprise a hose adapter or receptacle, to which a hose is affixed for applying the pressurized fluid as desired. The receptacle is usually a cylindrical protrusion extending outward from the vessel, that is capable of receiving a hose and clamp, or threaded to receive a fitting to which the hose is attached.

Generally, the aforementioned arrangements inhibit the freedom of the hose, thereby putting excessive stress on the hose and receptacle, and restricting the operator directing the hose.

One such system is the Compact Portable Sprayer with Leak-prevention system described in U.S. Pat. No. 6,412,707, issued on Jul. 2, 2002, the disclosure of which is incorporated herein by reference. The invention provides a portable sprayer comprising a liquid storage tank. Once the liquid is pressurized within the pressure vessel, it may be discharged through a pressure outlet. The pressure outlet is sealingly affixed to a hose and a control valve which may be used at the discretion of the operator to discharge pressurized liquid from the pressure vessel. As pointed out above, this arrangement puts excessive stress on the hose and receptacle, and restricting the operator directing the hose.

Additionally, sprayer tank connectors having swivel hose adapters are known. One such device is the Sprayer tank with combination hose outlet and pressure release valve is described in U.S. Pat. No. 6,155,497, issued on Dec. 5, 2000, the disclosure of which is incorporated herein by reference.

The invention provides a swivel hose adapter having an outer housing member and an internal housing which meshes with external threads on the proximal end of an inner housing member. The outer housing member is hollow and is formed with an outer flange defining bore which is adapted to receive a hose. Intermediate the ends of the outer housing member is internal shoulder which cooperates with the proximal end of the inner housing member to loosely receive therebetween a flange of a hose connector, allowing the hose connector to swivel within adapter.

The aforementioned invention further comprises a hose connector cooperating with surfaces of a flange to anchor the end of hose. The distal end of the hose connector is formed with an annular recess that receives an O-ring cooperating in sealing the junction between the distal end of the hose connector and the inner concentric cylinder on the proximal end of the inner housing member. The hose connector is formed with an internal bore that communicates with the bore of hose and the internal bore defined by cylinder.

While this invention solves many of the problems of the previously mentioned invention, the hose connector is not integral with the outer housing, requiring an additional component, and the related expense of assembly. Additionally, while the device allows the hose to swivel, the hose connector protrudes outward perpendicular to the base of the connector, still inhibiting the movement of the hose.

Accordingly, there is a need in the art for a vessel outlet swivel assembly with an integral hose connector. Furthermore, there is a need in the art for a swivel assembly that optimizes the operator's freedom of movement.

### SUMMARY

An outlet swivel assembly for a sprayer comprises an outlet swivel base configured for attachment to a vessel and an outlet swivel top rotably attached to the swivel base. The outlet swivel base has a receiving channel. The outlet swivel top has an outlet bore that is in fluid communication at an acute angle with the receiving channel. The outlet bore is configured for operable attachment to a hose so that the outlet swivel assembly serves as a conduit for delivering fluid from the vessel to the hose. A swivel clip can be used to attach the outlet swivel top to the outlet swivel base.

In some embodiments, the outlet top has an elongated annular groove for receiving and retaining the hose. The annular groove has a groove opening, a groove floor, a groove outer wall and a groove inner wall. The distance between the groove inner wall and the groove outer wall steadily decreases from the groove opening to the groove floor, thereby progressively narrowing the elongated annular groove.

### BRIEF DESCRIPTION OF THE DRAWINGS

These and other features, aspects and advantages of the present invention will become better understood with regard to the following description, appended claims and accompanying drawings where:

FIG. 1 is a side view of an outlet swivel assembly embodying the present invention;

FIG. 2 is a front exploded view of the outlet swivel assembly of FIG. 1;

FIG. 3 is a top view of the outlet swivel assembly of FIG. 1;

FIG. 4 is a side cross-sectional view of the outlet swivel assembly taken at line B-B of FIG. 3; and

FIG. 5 is a side prospective view of a sprayer vessel having the vessel outlet swivel assembly of FIG. 1 and a hose.

### DESCRIPTION

The present invention provides, in one form thereof, a vessel outlet swivel assembly with hose connector, wherein the hose projects outward at an angle that optimizes the operator's freedom of movement. Furthermore, the present invention provides a vessel outlet swivel assembly with an integral hose connector.

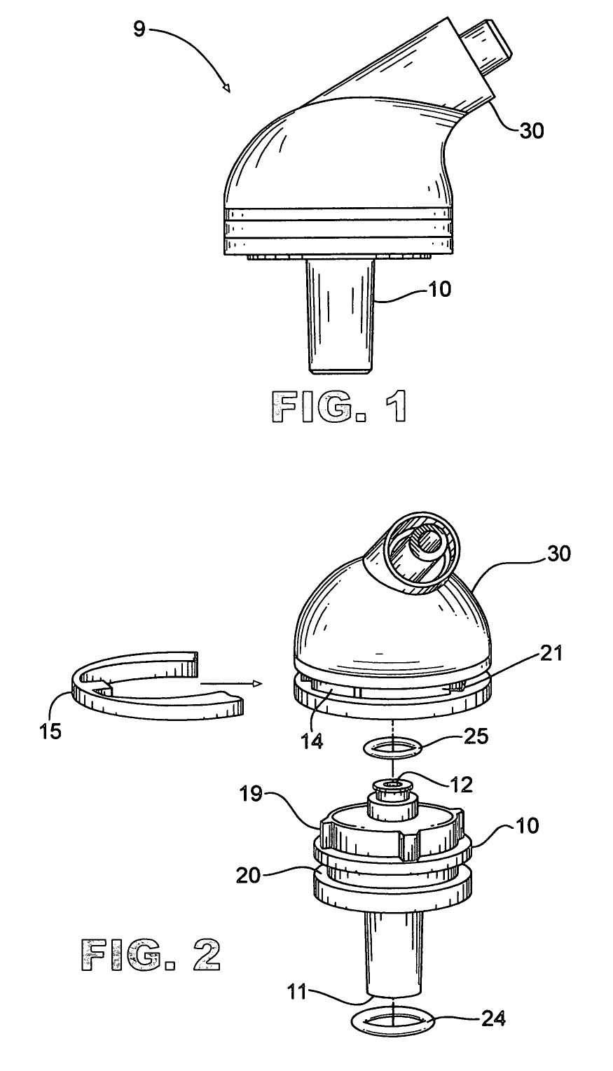

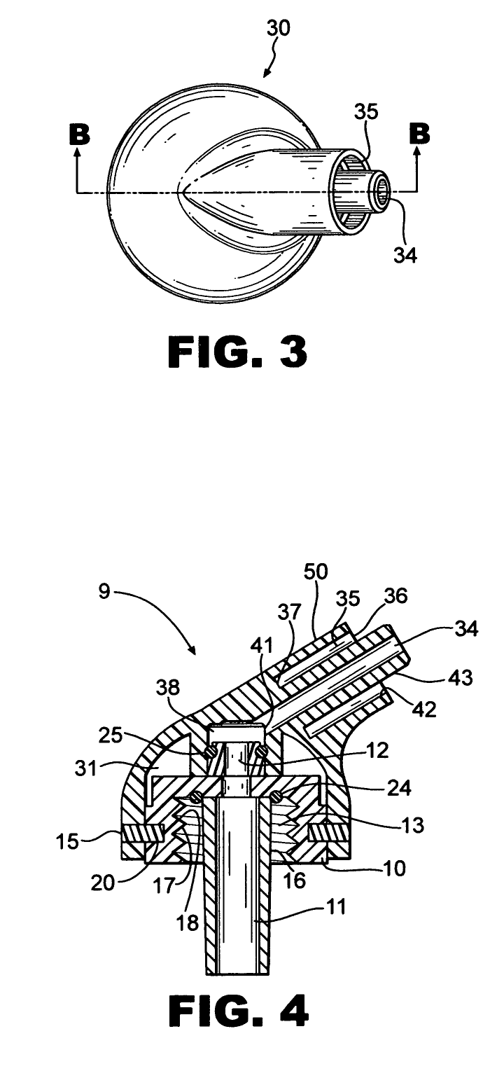

Referring now to the figures, particularly FIGS. 1 and 2, the swivel assembly 9 comprises a swivel outlet base 10, an outlet swivel top 30 and a swivel clip 15. The outlet swivel base 10, outlet swivel top 30 and swivel clip 15 are each preferably fabricated of one-piece integral plastic material by means of injection molding.

As can be seen in FIG. 2, the preferred embodiment of the assembly 9 also includes a base seal 24 and a cap seal 25. The outlet swivel base 10 comprises an annular clip groove 20, and the outlet swivel top 30 has a semi-annular orifice 21 with clip retaining slats 14. The clip retaining slats 14, clip 15, clip groove 20 and orifice 21 are all configured so that when the outlet swivel top 30 is placed over the swivel base 10, the orifice 21 can be aligned over the annular clip groove 20 and the swivel clip 15 can snap into place in the orifice 21 and the clip groove 20, thereby securely fastening the swivel top 30 to the swivel base 10 so that the swivel top can rotate upon the swivel base.

Referring now to FIG. 4, the outlet swivel base 10 further comprises a substantially spherical receiving channel 11, axially aligned, and in fluid communication with a substantially spherical discharge channel 12. Generally, the diameter of the spherical receiving channel 11 may be greater than the diameter of spherical discharge channel 12.

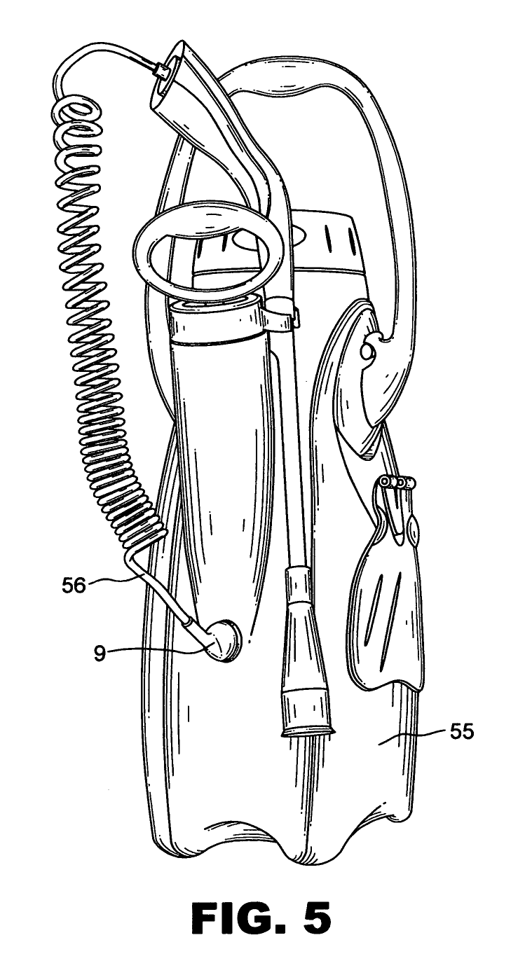

Additionally, the outlet swivel base comprises an annular mounting groove 13 having a pair of opposing walls 16 and 17, wherein one of said opposing walls comprises a threaded groove 18. The threaded groove 18, provides an example of a means for attaching the base member of the swivel assembly to a vessel, such as, for example, a sprayer or a pressure vessel 55 (shown in FIG. 5). However, any means for attaching may be used. In the embodiment illustrated in FIG. 2, the swivel base 10 has vertical lugs 19 so that a socket tool having the reverse feature can be used to secure the outlet swivel base 10 to the pressure vessel 55 via the threaded groove 18, as is well-known in the art.

The base seal 24 sits between the swivel base 10 and the vessel and the cap seal 25 sits between the swivel base 10 and the swivel top 30. The seals 24 and 25 may be comprised of appropriately sized o-rings, as is well-known in the art. The seals 24 and 25 minimize leakage of fluid traveling from the vessel through the assembly 9 to the hose 56 (shown in FIG. 5).

The swivel top 30 comprises a substantially hollow lower chamber 31, a radial bore 38, and a radial outlet bore 34. The bores 38 and 34 are in fluid communication with each other. When the swivel assembly 9 is assembled, a portion of the swivel base 10 fits inside the hollow lower chamber 31 of the outlet swivel top 30 and the discharge channel 12 fits inside the radial bore 38. The bores 38 and 34 and the channels 11 and 12 cooperate to form a conduit for delivering the fluid from the vessel 55 to the hose 56. More particularly, radial outlet bore 34 intersects the radial bore 38 at an orifice (not shown) formed in an angled sidewall 41 of the radial bore 38, and provides an outlet that is pitched at an acute angle relative to the channels 11 and 12.

Additionally, the outlet swivel top 30 has a push-turn hose connection 50. The push-turn connection 50 comprises an elongated annular groove 35, for receiving and retaining the hose 56. The elongated annular groove 35, further comprises a groove opening 36 and a groove floor 37, as well as a groove outer wall 42 and a groove inner wall 43. In a particular embodiment of the present invention, the distance between the groove inner wall 43 and the groove outer wall 42 steadily decreases from groove opening 36 to the groove floor 37. This progressively narrowing elongated annular groove 35, serves to pinch the hose to thereby provide a secure fit upon a push and turn of the hose 56. Generally, the hose 56 will have an inner surface and an outer surface, wherein the inner wall 43 will engage the inner wall of the hose. Additionally the outer surface of the hose will engage groove outer wall 42. This push-turn connection may be part of a separate connector, as the swivel outlet assembly, or may be part of a connector integral with a sprayer vessel or cap.

Although the present invention has been described in considerable detail with reference to certain preferred versions thereof, other versions are possible. For example, the outlet swivel top or base may be comprised of multiple pieces instead of each being a single integral piece and/or a single channel can be used in place of the spherical receiving channel and the discharge channel. Therefore, the spirit and scope of the appended claims should not be limited to the description of the preferred version contained herein.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function or “step for” performing a specified function should not be interpreted as “means for” or “steps for” clause as specified in 35 U.S.C. §112.

What is claimed is:

1. An outlet swivel assembly for a sprayer comprising:
(a) an outlet swivel base configured for attachment to a vessel, the outlet swivel base having a receiving channel; and
(b) an outlet swivel top rotably attached to the swivel base, the outlet swivel top having an outlet bore in fluid communication at an angle with the receiving channel; wherein the outlet bore is configured for operable attachment to a hose so that the outlet swivel assembly serves as a conduit for delivering fluid from the vessel to the hose.

2. The assembly of claim 1 wherein a swivel clip attaches the outlet swivel top to the outlet swivel base.

3. The assembly of claim 1 further comprising:
(c) a vessel operably attached to the outlet swivel base; and
(d) a hose operably attached to the outlet swivel top.

4. The assembly of claim 1 wherein the outlet swivel top has an elongated annular groove for receiving and retaining the hose, the annular groove having a groove opening, a groove floor, a groove outer wall and a groove inner wall, wherein the distance between the groove inner wall and the groove outer wall steadily decreases from the groove opening to the groove floor, thereby progressively narrowing the elongated annular groove.

5. A sprayer having push-turn hose connection comprising:
a sprayer vessel, the vessel being operably attached to a hose connector, the hose connector having an elongated annular groove for receiving and retaining a hose, the annular groove having a groove opening, a groove floor, a groove outer wall and a groove inner wall, wherein the distance between the groove inner wall and the groove outer wall steadily decreases from the groove opening to the groove floor, thereby progressively narrowing the elongated groove.

6. A sprayer having push-turn hose connection comprising:
a sprayer vessel, the vessel having an integral hose connector, the hose connector having an elongated annular groove for receiving and retaining a hose, the annular groove having a groove opening, a groove floor, a groove outer wall and a groove inner wall, wherein the distance between the groove inner wall and the groove outer wall steadily decreases from the groove opening to the groove floor, thereby progressively narrowing the elongated groove.
